(19) United States
(12) Patent Application Publication
(10) Pub. No.: US 2011/0277957 A1
(43) Pub. Date: Nov. 17, 2011

(54) DAMPING ELEMENT FOR HEAT DISSIPATING FAN

(76) Inventor: Chao-Chen Kuo, Xinzhuang City (TW)

(21) Appl. No.: 12/780,756

(22) Filed: May 14, 2010

(51) Int. Cl. F03D 11/00

(52) U.S. Cl. 165/69

(57) ABSTRACT

A damping element for a heat dissipating fan is made of a silica gel and includes a body member and a foot column extended from a first side surface of the body member. The foot column has a base portion extended from the body member, a column portion extended from the base portion and a head portion disposed at a free end of the foot column. A diameter of the base portion is larger than that of the column portion and a diameter of the head portion is larger than that of the column portion. The first side surface may include bumps. The damping element connects with the heat dissipating fan and the foot column is inserted into a hole of a computer casing. The bumps are contacted with the casing for absorbing the vibration of the fan and eliminating noise.

### BACKGROUND OF THE INVENTION

1. Field of the Invention

The present invention relates to a damping element capable of being easily installed on a heat dissipating fan, and after the heat dissipating fan is installed on a casing with thermal sources, vibrations are able to be effectively absorbed and noise is able to be eliminated.

2. The Prior Arts

A central processing unit (CPU) or IC chips installed in a computer would generate heat during operations and are heat sources in the computer. The thermal energy has to be immediately removed otherwise the CPU and the IC chips may be damaged by high temperature. Thus locations where the CPU and IC chips installed on a mother board are often directly installed heat dissipating fans for removing the thermal energy. Moreover, the thermal energy generated by the CPU and IC chips may remain in a casing of the computer mainframe, so another heat dissipating fan is installed at the casing for exhausting heated air out of the casing.

The heat dissipating fan is generally fastened on the casing by screws, i.e. the heat dissipating fan and the casing are in rigid contact. Vibrations generated by the heat dissipating fan would be directly transferred to the casing and then annoying noise is generated.

For solving the problems of vibrations and noise of the heat dissipating fan, the European Patent Number EP1617085 provides a solution that a heat dissipating fan includes a pad made of elastic material. When the heat dissipating fan is fastening on a casing, the elastic pad is in direct contact with the casing for absorbing vibrations generated by the heat dissipating fan, thereby eliminating noise. However, similar to the conventional design, the heat dissipating fan having the elastic pad provided by the European Patent Number EP1617085 is fastened on the casing by screws. Thus, the assembly is time-consuming

### SUMMARY OF THE INVENTION

A primary objective of the present invention is to provide a damping element for a heat dissipating fan; after the heat dissipating fan is installed on a casing, vibrations generated during operations are absorbed so as to eliminate noise.

Another objective of the present invention is to provide a damping element for a heat dissipating fan and the heat dissipating fan having the damping element is easy to install on a casing of a computer.

One feature of the present invention is to provide a damping element capable of matching the structure of a heat dissipating fan and being connected with the heat dissipating fan. Then, the connected heat dissipating fan and the damping element are mounted on a casing of a computer. A first side surface of the damping element contacted with the casing may include a plurality of bumps. If the damping element has the bumps, point contacts between the bumps and the casing absorb vibration generated by the heat dissipating fan, thereby eliminating noise. If the damping element does not have any bump, the first side surface of the damping element is in direct contact with the casing for absorbing the vibration.

Another feature of the present invention is that the damping element has a foot column having different diameters. After the damping elements are assembled with the heat dissipating fan, the foot columns are penetrated through holes preset on the casing. Then, the foot columns are stretched, so large-diameter portions of the foot columns are tightly fitted in the holes of the casing. Therefore, the heat dissipating fan is assembled on the casing without using any screw. The installation of the heat dissipating fan is much easier.

In view of the disclosures, the damping element according to the present invention is made of an elastic material, such as silica gel. The damping element includes a body member and a foot column extended from a first side surface of the body member. The foot column has a base portion disposed at a base end of the foot column, a column portion extended from the base portion and a head portion disposed at a free end of the foot column. A diameter of the base portion is larger than that of the column portion and a diameter of the head portion is larger than that of the column portion. The first side surface of the damping element may include a plurality of bumps. The damping element according to the present invention is connected with the heat dissipating fan and the foot column is penetrated through a hole of the casing that generates heat. The heat dissipating fan and the casing with thermal sources are assembled through stretching the foot column so the base portion is tightly fitted in the hole. If the damping element according to the present invention has the bumps, the bumps contact with the casing through a point contact for effectively absorbing vibrations and eliminating noise. If the damping element does not have any bump, the damping element directly contacts with the casing through a surface contact so a certain level of vibration absorbing and noise eliminating is still provided.

Serving as optional components, a pair of V-shaped embedding slots arranged at symmetrical positions is disposed on a second side surface, perpendicular to the first side surface of the body member, for receiving corresponding rhombus protrusions of the heat dissipating fan.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a perspective view showing a damping element according to a first embodiment of the present invention;

FIG. 2 is a perspective view showing the damping elements of FIG. 1 being viewed from another angle;

FIG. 3 is a partial exploded view showing the damping elements according to the present invention and a corresponding heat dissipating fan;

FIG. 4 is a detailed cross sectional view showing the damping element connected with the heat dissipating fan;

FIG. 5 is a perspective view showing the heat dissipating fan assembled with the damping elements, and a casing;

FIG. 6 is a perspective view showing foot columns of the damping elements being penetrated through the casing and being stretched;

FIG. 7 is a perspective view showing the heat dissipating fan being installed and fastened on the casing by the foot columns of the damping element;

FIG. 8 is a perspective view showing a damping element according to a second embodiment of the present invention and a corresponding heat dissipating fan; and

FIG. 9 is a perspective view showing the assembly of the components shown in FIG. 8.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

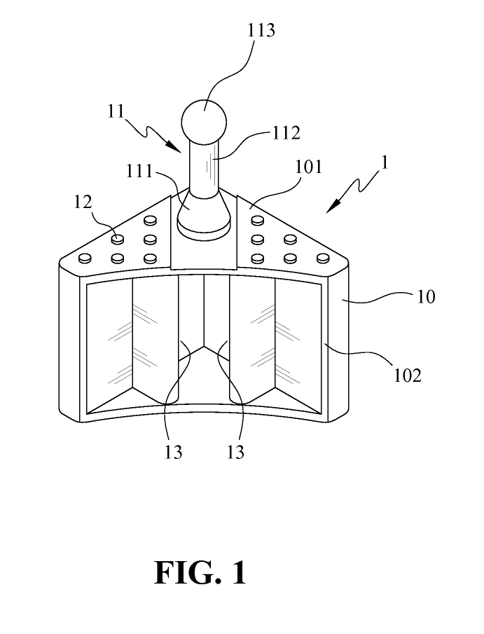

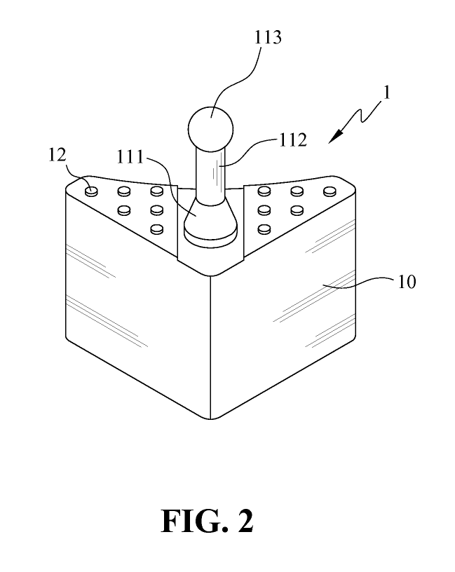

Referring to FIGS. 1 and 2, a damping element 1 for a heat dissipating fan 2 according to a first embodiment of the present invention is made of an elastic material, such as silica gel. The damping element 1 includes a body member 10 and a foot column 11 extended from a first side surface 101 of the body member 10. A base end of the foot column 11 includes a base portion 111. A column portion 112 is extended from the base portion 111 and has a diameter smaller than that of the base portion 111. A free end of the foot column 11 is formed with a head portion 113 having a diameter larger than that of the column portion 112. A plurality of bumps 12 are formed on the first side surface 101 of the body member 10. A second side surface 102, which is perpendicular to the first side surface 101 of the body member 10, includes a pair of embedding slots 13 arranged at symmetric positions. The embedding slot 13 according to the preferred embodiment of the present invention is in a V shape, so the two symmetric V-shaped embedding slots 13 form a rhombus space.

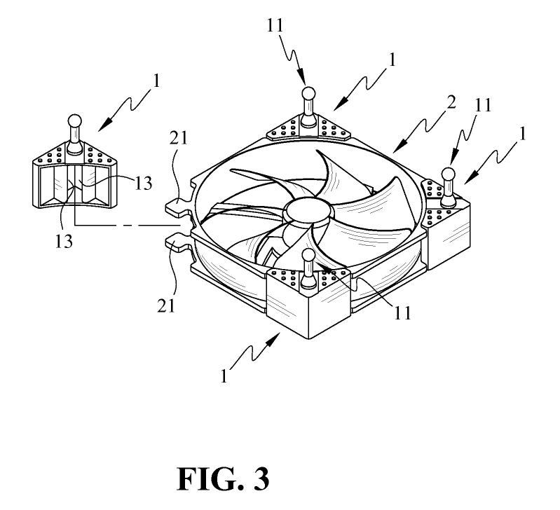

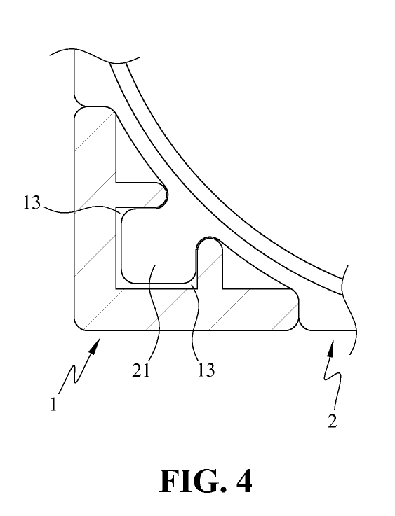

The body member 10 according to the preferred embodiment of the present invention is in a triangular shape. Unlike a conventional rectangular heat dissipating fan, each corner of the heat dissipating fan 2 (as shown in FIG. 3) is formed with a chamfer corresponding to the hypotenuse of the body member 10 so as to match the triangular damping element. Each chamfer includes two rhombus protrusions 21 corresponding to the space between the two V-shaped embedding slots 13. Referring to FIG. 4, when assembling the damping element 1 with the heat dissipating fan 2, the rhombus protrusions 21 are directly forced into the space between the two V-shaped embedding slots 13, thereby connecting the damping element 1 with the heat dissipating fan 2. When four corners of the heat dissipating fan 2 are assembled with the damping elements 1, a rectangular shape is defined by the damping elements 1 and the heat dissipating fan 2. Moreover, each foot column 11 is disposed at a same side of the heat dissipating fan 2.

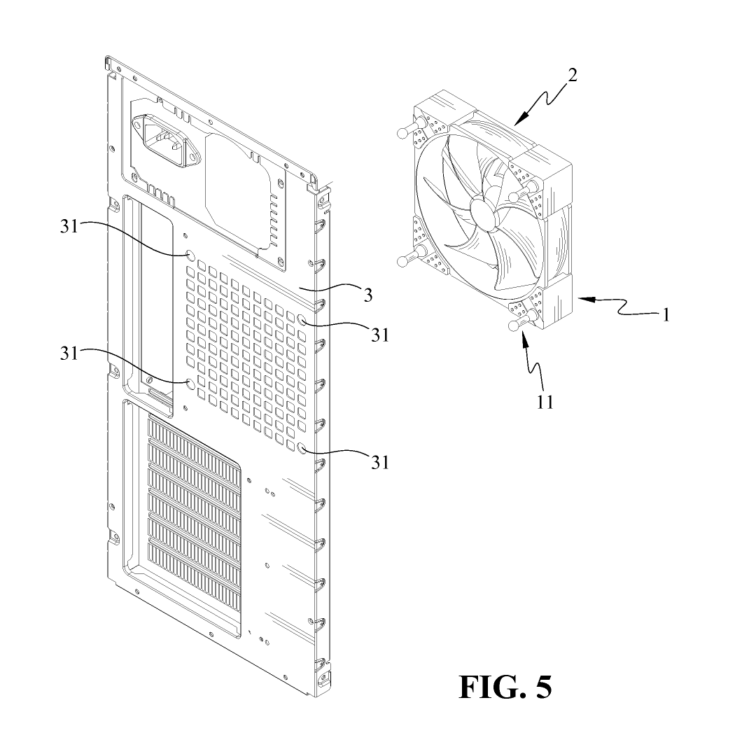

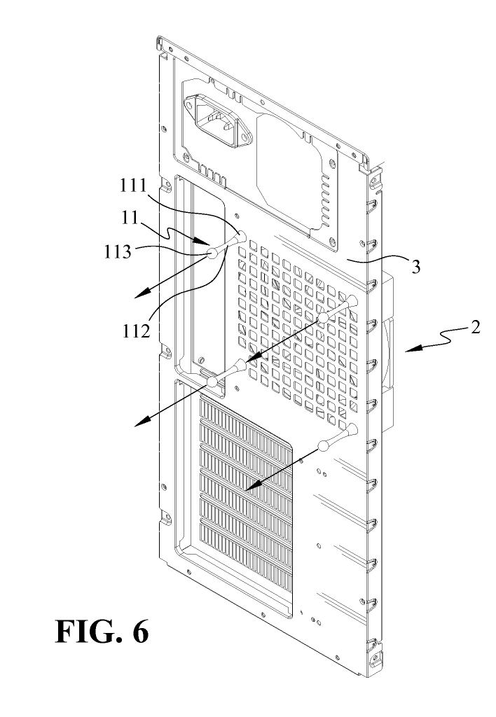

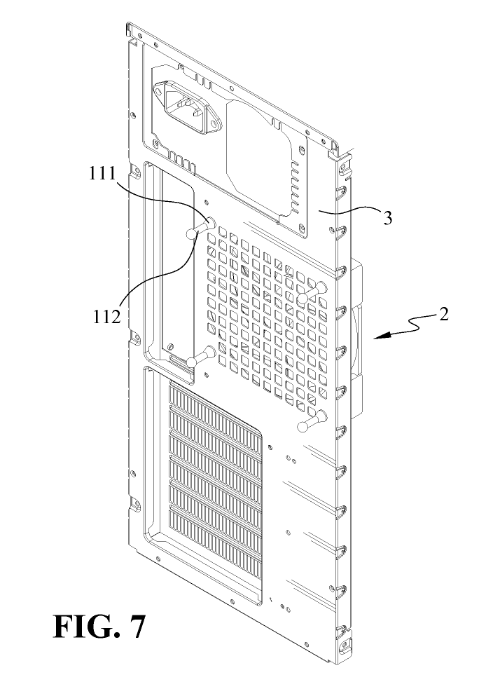

As shown in FIG. 5, a casing 3 of a computer mainframe includes a plurality of pre-drilled or pre-formed holes 31 corresponding to the foot columns 11 of the connected damping elements 1 and the heat dissipating fan 2. When the heat dissipating fan 2 having the damping elements 1 is assembled with the casing 3, each foot column 11 is aligned with and penetrated through the corresponding hole 31. Then the column portions 112, which have been penetrated though the holes 31, are axially stretched (as shown in FIG. 6), so the base portions 111 are tightly fitted in the holes 31 (as shown in FIG. 7). Therefore, the heat dissipating fan 2 is fastened on the casing 3. After the heat dissipating fan 2 is fastened on the casing 3, each bump 12 on the first side surface 101 of the damping element 1 is contacted with a surface of the casing 3 through a point contact, so vibrations generated during the operation of the heat dissipating fan 2 are effectively absorbed so as to eliminate noise.

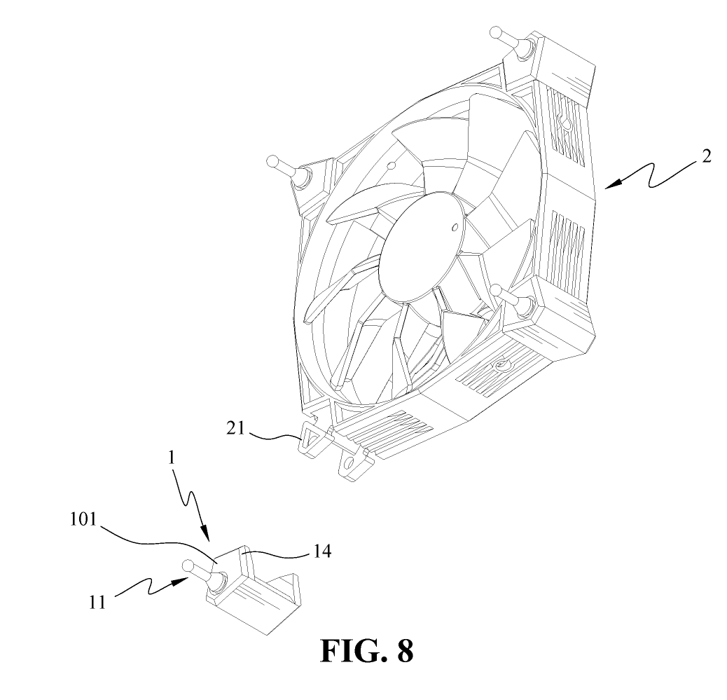

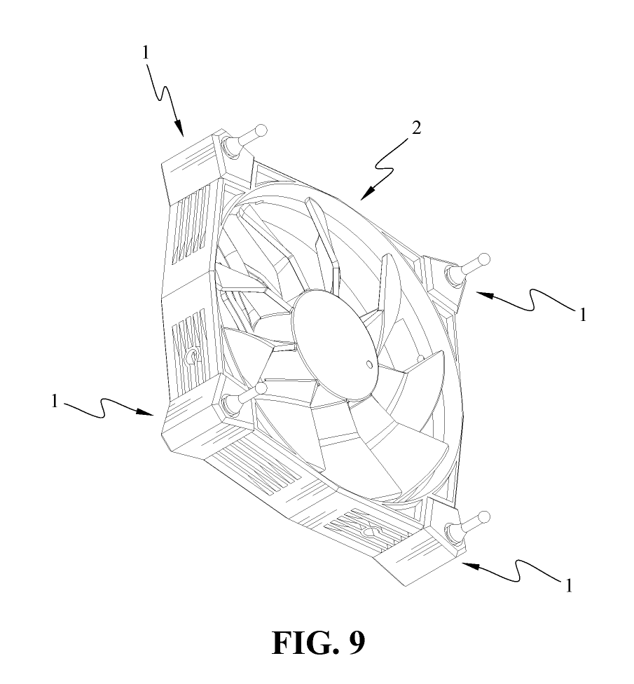

Referring to FIGS. 8 and 9, a damping element 1 according to a second preferred embodiment of the present invention has a structure similar to that of the first embodiment as shown in FIGS. 1 and 2. Compared with the damping element 1 according to the first embodiment having bumps 12, a first side surface 101 of the damping element 1 according to the second embodiment does not have any bump. Therefore, when the damping element 1 is installed on the heat dissipating fan 2 and assembled on the casing 3, the first side surface 101 of the damping element 1 is directly contacted with the surface of the casing 3, thereby absorbing the vibration generated by the heat dissipating fan 2.

Referring to FIGS. 8 and 9, each corner of the heat dissipating fan 2 is formed with a V-shaped cavity, and a protrusion 21 having a triangular head is extended from and integrally formed with the V-shaped cavity. A side of the body member 10 of the damping element 1 assembled with the heat dissipating fan 2 includes a V-shaped bulge 14 corresponding to the V-shaped cavity of the heat dissipating fan 2. Therefore, the damping element 1 and the heat dissipating fan 2 according to the second embodiment are assembled in a way similar to that of the first embodiment. The V-shaped bulge 14 of the damping element 1 is received in the V-shaped cavity of the heat dissipating fan 2; the protrusions 21 are forced into a space between the two embedding slots of the damping element 1; each foot column 11 faces toward the same direction.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A damping element for a heat dissipating fan, made of an elastic material and comprising:
a body member; and
a foot column extended from a first side surface of the body member, the foot column having a base portion extended from the body member, a column portion extended from the base portion and a head portion disposed at a free end of the foot column;
wherein the base portion has a diameter larger than that of the column portion and the head portion has a diameter larger than that of the column portion.

2. The damping element as claimed in claim 1, wherein the first side surface of the body member includes a plurality of bumps.

3. The damping element as claimed in claim 1, wherein a pair of embedding slots arranged at symmetrical positions are disposed on a second side surface, perpendicular to the first side surface of the body member, for receiving a corresponding protrusion of the heat dissipating fan.

4. The damping element as claimed in claim 3, wherein the embedding slot is in a V shape and the protrusion is in a quadrilateral shape.

5. The damping element as claimed in claim 3, wherein the embedding slot is in a V shape and the protrusion has a triangular end.

6. The damping element as claimed in claim 3, wherein the protrusions are disposed at each corner of the heat dissipating fan, the body member of the damping element is in a triangular shape, a rectangular shape is defined after the damping elements are assembled at the corners of the heat dissipating fan.

7. The damping element as claimed in claim 2, wherein a pair of embedding slots arranged at symmetrical positions are disposed on a second side surface, perpendicular to the first side surface of the body member, for receiving a corresponding protrusion of the heat dissipating fan.

8. The damping element as claimed in claim 7, wherein the embedding slot is in a V shape and the protrusion is in a quadrilateral shape.

9. The damping element as claimed in claim 7, wherein the embedding slot is in a V shape and the protrusion has a triangular end.

10. The damping element as claimed in claim 7, wherein the protrusions are disposed at each corner of the heat dissipating fan, the body member of the damping element is in a triangular shape, a rectangular shape is defined after the damping elements are assembled at the corners of the heat dissipating fan.

11. The damping element as claimed in claim 1, wherein a side of the body member to connect with the heat dissipating fan comprises a V-shaped bulge.
